(19) United States
(12) Patent Application Publication
(10) Pub. No.: US 2011/0000556 A1
(43) Pub. Date: Jan. 6, 2011

(54) NON-RETURN VALVE HAVING IMPROVED AUTOMATIC RECIRCULATION

(76) Inventor: RAINER KLEMM, Doussard (FR)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/830,015

(22) Filed: Jul. 2, 2010

(30) Foreign Application Priority Data
Jul. 6, 2009 (FR) 0954646

(51) Int. Cl. F16K 21/04

(52) U.S. Cl. 137/511

(57) ABSTRACT

An automatic recirculation non-return valve comprises a check valve located in a main duct and a recirculation valve located in a recirculation duct. The check valve is movable between extreme positions of closing and opening the flow cross-section of the main duct. The recirculation duct forms a branch of the main duct upstream of the check valve. The check valve comprises a rotary shutter and a seat cooperating with each other to define a flow cross-section of the recirculation duct. A transmission mechanism couples the movement of the check valve and that of the shutter. The recirculation valve comprises a pressure-balancing mechanism configured in such a manner that, of the downstream surfaces of the shutter, at least one surface is not involved in sealing and is subjected to a pressure substantially equal to the pressure exerted on the upstream surfaces of the shutter.

### TECHNICAL FIELD

The disclosure relates to an automatic recirculation non-return valve.

### BACKGROUND

Automatic recirculation non-return valves include:

a check valve located in a main duct of a non-return valve, with the check valve being movable between extreme positions of complete closure and maximum opening, respectively, of a flow cross-section of a main duct;

a recirculation valve located in a recirculation duct forming a branch of the main duct, upstream of the check valve, the recirculation valve including, upstream, a rotary shutter and, downstream, a seat on which the shutter is applied, the shutter and the seat cooperating with each other to define a flow cross-section of the recirculation duct; and

transmission means coupling the check valve and the shutter of the recirculation valve in such a manner that the flow cross-section of the recirculation duct depends on the flow cross-section of the main duct.

In the type of non-return valve having a rotary shutter, the opening or closing of the recirculation valve is problematic because, in order to cause the shutter to rotate, it is necessary to apply a substantial moment thereto capable of overcoming the frictional forces generated on the sealing surfaces, which correspond to the surfaces on which the shutter and the seat are in contact.

### SUMMARY

An automatic recirculation non-return valve of the above-mentioned type is disclosed, wherein the recirculation valve comprises pressure-balancing mechanism configured in such a manner that, of downstream surfaces of the shutter, that is to say, surfaces oriented towards the seat, at least one surface is not involved in the sealing of the recirculation valve and is subjected to a fluid pressure substantially equal to the pressure exerted on the upstream surfaces of the shutter.

According to exemplary embodiments, the non-return valve comprises one or more of the following features, taken individually or in accordance with any technically possible combination:

a seat and a shutter are rotationally symmetrical about a common axis, and the shutter is mounted to rotate about that axis, relative to the seat;

the shutter and the seat between them delimit a cavity, and the pressure-balancing mechanism comprises a passage extending through a wall of the shutter to lead into the cavity;

the seat has upstream surfaces forming a generally conic frustum, and the shutter comprises a recess defining downstream surfaces of the shutter which form a conic frustum complementing that formed by the upstream surfaces of the seat, a base of the recess and a small base of the seat delimits the cavity;

an axis of the seat and of the shutter is arranged generally perpendicularly to and at a distance from an axis of the check valve;

the transmission mechanism comprises a lever which is mounted to pivot relative to bodies of the non-return valve and a first end of which cooperates with the check valve in such a manner that it can be caused to tilt by the check valve and the other end of which comprises an activating mechanism suitable for driving the shutter in rotation;

the activating mechanism may comprise a toothed segment mounted at a second end of the lever, the toothed segment meshing with a toothed wheel provided on the shutter; and

the toothed segment and the toothed wheel are located in the same plane perpendicular to the axis of rotation of the shutter.

### BRIEF DESCRIPTION OF THE DRAWINGS

The disclosure and its advantages will be better understood on reading the following description which is given purely by way of example and with reference to the appended drawings in which:

FIG. 1 is a diagrammatic representation of a hydraulic circuit, including an automatic recirculation non-return valve;

FIG. 2 is a sectioned view of the non-return valve of FIG. 1;

FIG. 3 is a sectioned view, in accordance with the line III-III of FIG. 2, of the non-return valve;

FIG. 4 is a sectioned view of a shutter of the recirculation valve shown in FIG. 3; and

FIG. 5 is an enlarged sectioned view of a seat of the recirculation valve of FIG. 3.

### DETAILED DESCRIPTION

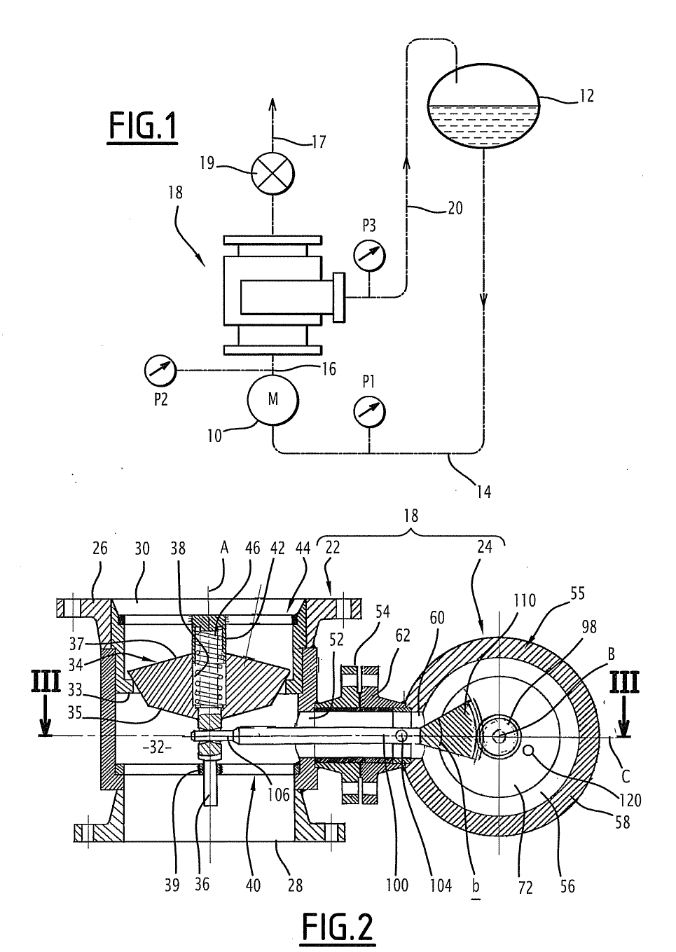

The general operating principle of an automatic recirculation non-return valve is known. Referring to FIG. 1, a pump 10, for example of the centrifugal type, is supplied via an admission line 14 with a liquid contained in a reservoir 12. Upstream of the pump 10, the liquid is at pressure P₁.

The pump 10 delivers the liquid in a delivery line 16. Downstream of the pump 10, the liquid is at a pressure P₂.

It is known to install, downstream of the pump, along the delivery line 16, an automatic recirculation non-return valve 18 and a regulating slide valve 19.

Such a non-return valve 18 subdivides the incoming flow, corresponding to the flow delivered by the pump 10, into a required flow delivered towards the downstream portion 17 of the delivery line 16, and into a recirculated flow delivered to the supply circuit via a recirculation line 20. In the embodiment of FIG. 1, the recirculation line 20 connects the valve 18 to the reservoir 12. The pressure in the recirculation line 20 is equal to pressure P₃ lower than pressure P₂ but, a priori, different from pressure P₁.

The function of the regulating slide valve 19, downstream of the valve 18, is to fix the rate of flow along the downstream portion 17 of the delivery line 16.

In order to keep the pump 10 within a suitable operating range, wherein a delivered flow greater than a minimum threshold flow and, consequently, to protect it against too weak a flow, the function of the non-return valve 18 is to bring about the recirculation of a flow complementing the main flow set by the regulating slide valve 19 so that the flow delivered by the pump is maintained above the minimum threshold flow. For example, the minimum threshold flow of the pump 10 being 400 m³/h, when the main flow is 200 m³/h, the recirculated flow is 200 m³/h in order to maintain the minimum admissible flow for the pump 10. When the main flow set by the regulating slide valve 19 exceeds 400 m³/h, the recirculation is closed.

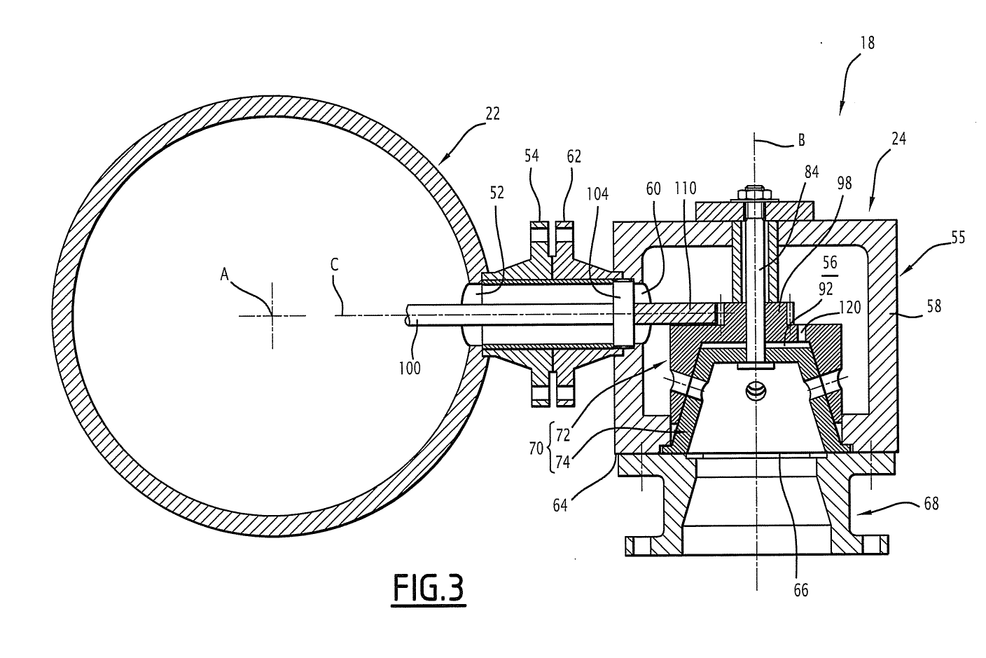

As shown in section in FIGS. 2 and 3, the valve 18 comprises a first, non-return, device 22 and a second, recirculation, device 24.

The first device 22 comprises a first body 26 having a tubular shape about an axis A. The first body 26 delimits internally, between an upstream admission opening 28 and a downstream delivery opening 30, of a main duct 32.

The first body 26 contains internally a check valve 34 cooperating with a valve seat 33 fixedly joined to the first body 26.

The valve 34 is rotationally symmetrical about an axis which, when the valve 34 is mounted inside the first body 26, coincides with the axis A.

On the side where an upstream face 35 is located, the valve 34 comprises a rod 36 extending axially beyond the valve 34. On the side where a downstream face 37 is located, the valve 34 comprises a bore 38 extending axially.

The valve 34 is mounted by inserting the free end of the rod 36 into an axial orifice 39 of an upstream centring device 40 and by accommodating, inside the bore 38, a hollow rod 42 of a downstream centring device 44. The upstream and downstream centring devices are fixedly joined to the first body 26.

A spring 46 is accommodated inside the bore 38 and the hollow rod 42. It is supported, on the one hand, on the base of the bore 38 and, on the other hand, on the base of the hollow rod 42. The spring 46 works compressively to push the valve 34 back from downstream to upstream, against the seat 33.

The valve 34 is mounted in such a manner as to be movable in translation along the axis A between two extreme positions:

an extreme position of the valve 34 corresponding to a complete closure of the flow cross-section of the main duct 32, which is defined by causing the upstream face 35 of the valve 34 to be supported against the seat 33; and

a position of maximum opening of the flow cross-section of the main duct 32, which is defined by causing the base of the bore 38 of the valve 34 to abut the hollow rod 42.

The function of the spring 46 is to bias the valve 34 against the seat 33 and to oppose the displacement of the valve 34.

The valve 34 rises and moves downstream, along the axis A, when the difference between the pressures exerted on the upstream face 35 and on the downstream face 37 is greater than a predetermined threshold difference, for example from 0.5 to 1 bar. As soon as the reduced pressure downstream of the valve 34 is no longer sufficient, the valve returns to rest on its seat, closing the main duct 32 and preventing a return of liquid from downstream to upstream.

Upstream of the valve 34, a lateral wall of the first body 26 comprises a branch orifice 52.

The first device 22 comprises, secured to the outside of the first body 26, a first tubular securing flange 54, inside which the branch orifice 52 opens out.

The first securing flange 54 enables the second, recirculation, device 24 to be fixedly joined to the first, non-return, device 22.

The second, recirculation, device 24 will now be described.

The second, recirculation, device 24 comprises a second body 55 forming a cylindrical casing of axis B, delimiting internally a chamber 56.

A lateral wall 58 of the second body 55 comprises an inlet orifice 60.

The second device 24 comprises, secured to the outside of the second body 55, a second tubular securing flange 62, inside which the inlet orifice 60 opens out. The second securing flange 62 is suitable for cooperating with the first securing flange 54 in such a manner as to secure the first and second devices to each other and to connect them fluidically. In the embodiment of the Figures, the axes of the branch orifice 52 and the inlet orifice 60 coincide along an axis C, and the second body 55 is mounted on the first in such a manner that its axis B is perpendicular to, and not concurrent with, the axis A of the first body.

The downstream end wall 64 of the second body 55 comprises a through-orifice forming an outlet orifice 66 of the second body 55, which is to be connected to the recirculation line 20. For that purpose, a wall 64 carries externally a suitable clamp 68.

Thus, the valve 18 comprises a recirculation duct extending between the branch orifice 52 and the outlet orifice 66, through the securing flanges 54 and 62 of the first and second bodies, and the chamber 56 of the second body.

The second body 55 comprises internally a recirculation valve 70 enabling the flow cross-section of the recirculation duct to be selectively modified. The recirculation valve 70 comprises a shutter 72 and a seat 74.

The shutter 72 and the seat 74 are rotationally symmetrical about an axis coinciding with the axis B. The shutter 72, which is in the general shape of a bell, fits over the seat 74, which has a complementary shape.

The shutter 72 can be activated to rotate about the axis B relative to the seat 74.

The shutter and the seat comprise through-holes, the alignment of which is modified during the displacement of the shutter in order to adapt the flow cross-section through the recirculation valve 70.

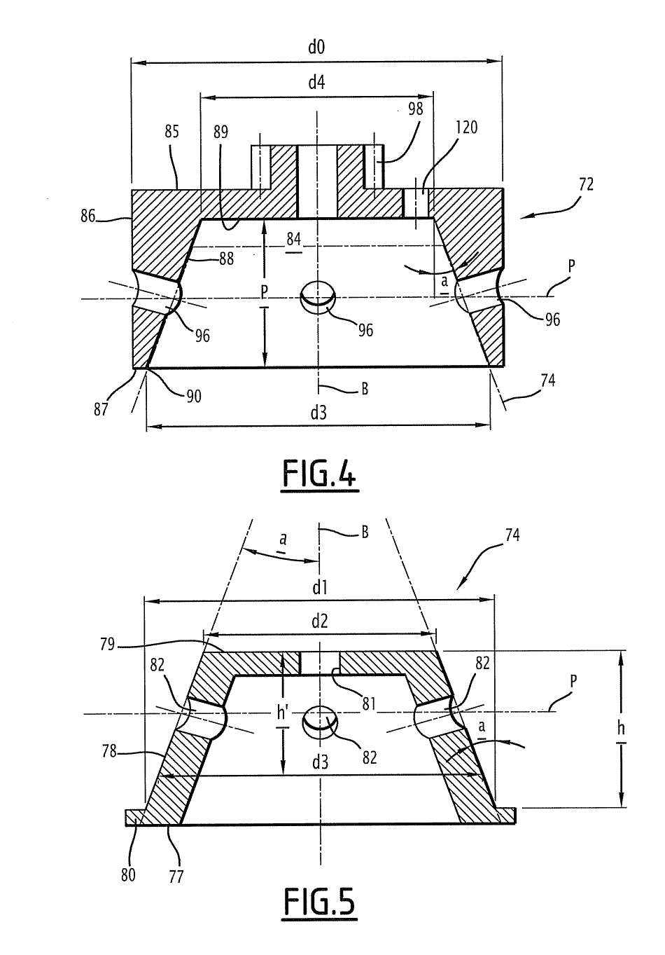

In the embodiment shown in FIGS. 4 and 5, the wall of the seat 74 has:

upstream surfaces comprising a generally frustoconical lateral surface 78 and an end surface or small base 79. The frustoconical lateral surface extends over height h between a cross-section having a first outside diameter d1 and a cross-section having a second outside diameter d1, smaller than the first diameter d1, so that the frustoconical lateral surface 78 forms an angle a relative to the axis B. The cross-section of diameter d2 forming the small base of the conic frustum corresponds to the end surface 79.

The end surface 79 comprises an axial bore 81 permitting the mounting of a shaft 84 about which the shutter 72 is mounted to rotate freely.

The base 77 of the seat 74 has a collar 80 permitting the mounting of the seat on a suitable shoulder formed on the periphery of the outlet orifice 66.

The wall of the seat 74 is provided with a plurality of through-holes 82 which open out, substantially at right-angles, on the frustoconical lateral surface 78. They are arranged in such a manner that their centres, on the frustoconical lateral surface 78, are in a plane P transverse to the axis B. In the embodiment shown, the seat 74 comprises four holes 82 which, in projection in the plane P, are arranged at 90° to each other.

The shutter 72 of the slide valve 70 will now be described.

The shutter 72, having a cylindrical external shape, has internally a frustoconical recess 84 suitable for receiving the seat 74 by nesting.

To be more precise, the wall of the shutter 72 is configured in such a manner as to have:

upstream surfaces which define a cylinder of axis B and of diameter d0, and which comprise an upper end surface 85, a lateral surface 86, and a lower end surface 87 of annular shape; and

downstream surfaces which define a conic frustum of axis B and which comprise a frustoconical lateral surface 88 and an end surface forming a base 89 of a recess 84.

The frustoconical lateral surface 88 extends to depth p between a cross-section of inside diameter d3 and a cross-section of inside diameter d4, smaller than the diameter d3. The frustoconical lateral surface 88 forms an angle a with the axis B. That angle is identical to the angle of the seat 74. The cross-section of diameter d4 corresponding to the small base of the conic frustum coincides with the base 89.

The diameter d3 is smaller than the diameter d1 of the seat, but larger than the diameter d2, and the diameter d4 is smaller than the diameter d2 of the seat, in order to be able to nest the seat and the shutter one on the other.

The depth p of the recess 84 is such as to be greater than the distance h′, considered on the seat 74, between the cross-section of the frustoconical lateral surface 78 of diameter d3 and the end surface 79. Thus, when the shutter is nested on the seat, a cavity 92 (FIG. 3) is formed between the base 89 of the shutter and the end surface 79 of the seat. On the other hand, the frustoconical lateral surfaces 88 and 78 of the shutter and the seat, respectively, supported against each other, define the sealing surfaces of the recirculation valve 70.

The wall of the shutter 72 comprises a plurality of through-holes 96 which open out, substantially at right-angles, on the frustoconical lateral surface 88 so that their centres are situated in a plane transverse to the axis B, coinciding with the plane P when the shutter is covering the seat. The shutter comprises four holes 96 which are aligned with the holes 82 of the seat 74 for a precise angular position of the shutter relative to the seat.

The end surface 85 comprises a wheel 98 of axis B for activating the shutter in rotation.

In order to constrain the flow cross-section of the recirculation duct in accordance with the flow cross-section of the main duct, the valve 18 comprises an activating mechanism configured to open the recirculation valve 70 in accordance with the opening of the valve 34.

The activating mechanism comprises a lever 100 which is arranged in such a manner as to extend through the branch orifice 52 and the inlet orifice 60, substantially along the axis C of the tubular flanges 54 and 62.

The lever 100 is connected to the second body 24 by a first pivot connection, the shaft 104 of which is perpendicular to the axis A so that the lever is displaced in a plane containing the axis A.

A first end 106 of the lever 100 is coupled to the rod 36 of the check valve 34 by a second connection permitting both a sliding movement of the point of contact between the end 106 and the rod 36 and a tilting of the lever 100 relative to the rod 36 about an axis parallel with the shaft 104.

A second end of the lever 100 comprises a sector 110. The sector 110, the center of which coincides with a point on the axis of rotation of the first pivot connection, has an angular opening b. Its periphery carries teeth suitable for cooperating with teeth of the shutter wheel 98. In one exemplary embodiment, the segment 110 and the wheel 98 are located in the same plane which corresponds to the plane of displacement of the lever 100.

When the main duct is closed, the valve 34 rests on its seat 33. The lever 100 then coincides with the axis C. The relative position of the toothed sector 110 and the shutter wheel 98 defines the position of maximum opening of the recirculation valve 70 in which the holes 96 of the shutter are aligned with the holes 82 of the seat.

When the difference in the pressures lifts the valve 34 away from its seat 33, the end portion 106 of the lever 100 is displaced substantially along the axis A, causing a pivoting of the lever 100 and the rotation of the toothed sector 110. The latter applies a moment to the shutter suitable for causing it to rotate about the axis B. As that happens, the holes 96 of the shutter and the holes 82 of the seat become misaligned and the flow cross-section of the recirculation duct decreases.

The maximum displacement of the check valve, the distances between each of the ends of the lever and the pivot axis thereof, and the ratio of the radii of the toothed sector and of the toothed wheel are determined in such a manner that the position of closing the check valve corresponds to the alignment of the holes of the shutter with those of the seat, that is to say, the opening of the recirculation valve, and that the position of maximum opening of the check valve corresponds to a distance between a hole of the shutter and a hole of the seat sufficient to ensure sealing, that is to say, the closing of the recirculation valve.

The frictional force which opposes the rotational displacement of the shutter on the seat depends on the supporting force of the shutter on the seat.

In order to limit the supporting force of the shutter on the seat, the recirculation valve 70 comprises a pressure balancing mechanism to enable the cavity 92 to be brought into fluid communication with the chamber 56 so that the fluid pressure exerted in the cavity is substantially equal to that applied to the upstream surfaces of the shutter 72, in this case the pressure P₃. In the embodiment shown in the Figure, the exemplary pressure-balancing mechanism is a passage 120 leading, on the one hand, to the base 89 and, on the other hand, to the end surface 85 of the shutter 72.

In the following, it will be shown that the resultant pressure force on the shutter depends, among other parameters, on the angle a.

Of the shutter surfaces oriented downstream, that is to say, in the direction towards the seat, most of the frustoconical lateral surface 88 of the shutter bears against the frustoconical lateral surface 78 of the seat. Those mutually bearing surfaces define the sealing surfaces of the slide valve 70. Consequently, the fluid pressure, which is exerted on the frustoconical lateral surface 88, is substantially zero. The pressure on the frustoconical surface which lies between the cross-sections of diameter d2 and d4 and which delimits the cavity 92 laterally, is disregarded here since the height h′ and the depth p are similar, the cavity having a reduced height.

In addition, owing to the presence of the passage 120, the base 89 of the recess 84 is subjected to a pressure equal to the pressure P₂. The resultant pressure force F₈₉ is given by:

$${F}_{89} = {P}_{2} \times \frac{π}{4} {d}_{4}^{2}$$

On the upstream side of the shutter, the pressure forces exerted on the lateral surface 86 do not deform the shutter. The lateral surface 86 remains cylindrical and the pressure forces applied thereto do not have a resultant along the axis B. Consequently, the pressure forces exerted on the lateral surface 86 are not involved in the support of the shutter on the seat.

Only the pressure forces exerted on the end surfaces 85 and 87 are to be considered. They are expressed in the following manner:

$${F}_{85} = {P}_{2} \times \frac{π}{4} {d}_{0}^{2}$$

$${F}_{87} = {P}_{2} \times \frac{π}{4} ( {d}_{0}^{2} - {d}_{3}^{2} )$$

The resultant F of the pressure forces along the axis B on the shutter 72 is: F=F₈₅−F₈₉−F₈₇

$$Let \text{:} F = {P}_{2} \times \frac{π}{4} ( {d}_{3}^{2} - {d}_{4}^{2} )$$

$$Now , tg ( a ) = \frac{{d}_{3} - {d}_{4}}{2 p}$$

$$Hence , finally , F = {P}_{2} \times \frac{π}{4} ( {( 2 p \times tg ( a ) + {d}_{4} )}^{2} - {d}_{4}^{2} )$$

That resultant depends on the tangent of the angle a, the diameter d4 of the base 89 and the depth p of the recess 84.

Consequently, at a given depth p and a given diameter d4, by selecting a particular angle a, it is possible to adapt the frictional force of the shutter on the seat. A value of the angle a is chosen to ensure sufficient support to guarantee the sealing of the slide valve 70, without interfering with the activation of the shutter in rotation.

The person skilled in the art will appreciate that numerous variants of the slide valve and, in particular, of the pressure-balancing mechanism may be envisaged without departing from the present disclosure.

What is claimed is:

1. An automatic recirculation non-return valve comprising:
a check valve located in a main duct of the non-return valve, the check valve movable between extreme positions of complete closure and maximum opening, respectively, of a flow cross-section of the main duct;
a recirculation valve located in a recirculation duct forming a branch of the main duct, upstream of the check valve, the recirculation valve comprising, upstream, a rotary shutter and, downstream, a seat, wherein the shutter and the seat cooperate with each other to define a flow cross-section of the recirculation duct;
a transmission mechanism coupling movement of the check valve and that of the shutter in such a manner that the flow cross-section of the recirculation duct depends on the flow cross-section of the main duct,
wherein the recirculation valve comprises a pressure-balancing mechanism configured in such a manner that, downstream surfaces of the shutter, that is to say, surfaces oriented towards the seat, at least one surface is not involved in sealing of the recirculation valve and is subjected to a fluid pressure substantially equal to a pressure exerted on upstream surfaces of the shutter.

2. The valve according to claim 1, wherein the seat and the shutter are rotationally symmetrical about a common axis, and the shutter is mounted to rotate about that axis, relative to the seat.

3. The valve according to claim 1 wherein the shutter and the seat between them delimit a cavity, and wherein the pressure-balancing mechanism comprises a passage extending through a wall of the shutter to lead into the cavity.

4. The valve according to claim 3, wherein the seat has upstream surfaces forming a conic frustum, and the shutter comprises a recess defining the downstream surfaces of the shutter which form a conic frustum complementing that faulted by the upstream surfaces of the seat, a base of the recess and a small base of the seat delimiting the cavity.

5. The valve according to claim 2, wherein the axis (B) of the seat and of the shutter is arranged perpendicularly to and at a distance from the axis (A) of the check valve.

6. The valve according to claim 5, wherein the transmission mechanism comprises a lever which is mounted to pivot relative to the bodies of the non-return valve and a first end of which cooperates with the check valve in such a manner that the lever can be caused to tilt by the check valve and a second end of which comprises an activating mechanism suitable for driving the shutter in rotation.

7. The valve according to claim 6, wherein the activating mechanism comprises a toothed segment mounted at the second end of the lever, the toothed segment meshing with a toothed wheel provided on the shutter.

8. The valve according to claim 7, wherein the toothed segment and the toothed wheel are located in the same plane perpendicular to the axis (B) of rotation of the shutter.
